(19) United States
(12) Patent Application Publication
(10) Pub. No.: US 2024/0320121 A1
(43) Pub. Date: Sep. 26, 2024

(54) POWER CONSUMPTION ESTIMATION SYSTEM, POWER CONSUMPTION ESTIMATION METHOD, AND POWER CONSUMPTION ESTIMATION PROGRAM

(71) Applicant: Hitachi, Ltd., Tokyo (JP)

(72) Inventors: Pritam Jaywant CHAUDHARI, Tokyo (JP); Yoji OZAWA, Tokyo (JP); Satoshi KANEKO, Tokyo (JP)

(21) Appl. No.: 18/235,989

(22) Filed: Aug. 21, 2023

(30) Foreign Application Priority Data
Mar. 20, 2023 (JP) 2023-044191

(51) Int. Cl. G06F 11/34; G06F 1/3206; G06F 9/50

(52) U.S. Cl. CPC G06F 11/3452; G06F 1/3206; G06F 9/505; G06F 11/3433

(57) ABSTRACT

To estimate power consumption of a workload, an estimation server estimates power consumption of a workload executed on a physical server. A processor trains a plurality of short-range power models that receive a metric of the physical server as an input and output a power consumption value of the physical server in a plurality of short ranges obtained by dividing an entire power range of the physical server into a predetermined division number, trains a classifier that receives a metric of the physical server as an input and outputs specification information specifying a corresponding short range and specifies specification information specifying a short range to be applied based on a metric of the workload and the classifier. The estimate of the power consumption of the workload is based on the metric of the workload and a short-range power model corresponding to the short range indicated by the specification information.

### CROSS-REFERENCE TO RELATED APPLICATION

The present application claims priority from Japanese application JP2023-044191, filed on DATE, the content of which is hereby incorporated by reference into this application.

### BACKGROUND OF THE INVENTION

### 1. Field of the Invention

The present invention technique for estimating power consumption of a workload executed on a physical server.

### 2. Description of Related Art

In a typical workload execution environment, diverse workloads are executed side-by-side in a single physical server to save infrastructure costs. Here, a workload refers to software executed on a virtual machine constructed on a physical server.

These workloads have diverse power consumption characteristics, with some workloads being low-power-consumption workloads and others being power intensive workloads.

If the power consumption amount of individual workloads can be estimated, it may be helpful in meeting demand and implementing green computing measures. Examples thereof include delaying power-intensive workloads to a period of energy surplus or renewable energy if possible, or moving power-intensive workloads to data centers with energy surplus or renewable energy supply.

Further, emission amounts of individual workloads can be calculated from estimated power consumption amount thereof, which can help make decisions at an individual workload level to achieve high-level emission reduction targets.

PTL 1 discloses a method of attributing a portion of a server's power consumption to a workload executed by the server based on a load level imposed on the server by the workload. The level of load can be determined based on the utilization of resources such as a processor, a memory, a disk and a network. A regression model can be used to map the load level of a workload in the form of server resource usage to a fraction of the server's total power consumption.

### CITATION LIST

### Patent Literature

PTL 1: U.S. Pat. No. 8,751,844B

### SUMMARY OF THE INVENTION

For example, power consumption of a workload may be estimated using a single linear regression model. This single linear regression model is trained, for example, on a data set with the full range of power consumption in servers.

For example, an intercept of the single linear regression model attempts to model a mean value of a data set of training data, which can be large if the training data is high-power data. Therefore, there is a risk of overestimating the power consumption of the workload. The intercept can be interpreted as the overhead component of the power consumption of the workload due to the os (operating system) and middleware that support the workload, increased heat dissipation by the workload, and other factors.

In a typical data center, there are many low-power-consumption workloads and some others are power intensive workloads. However, models trained on data sets with power-intensive workloads may overestimate the power consumption of low-power-consumption workloads.

The technique disclosed in PTL 1 does not address the problem of overestimation observed when the training data distribution contains a long tail of high-power data points.

Further, workload scheduling and migration decisions based on such overestimation of workload power consumption may not result in increased utilization in server resources and renewable energy supplies.

The present invention has been made in view of the circumstances described above, and an object of thereof is to provide a technique capable of optimally estimating power consumption of a workload.

To achieve the above object, a power consumption estimation system according to one aspect is a power consumption estimation system that estimates power consumption of a workload executed on a physical server, and the power consumption estimation system includes a processor. The processor trains a plurality of short-range power models as power models that receive a metric of the physical server as an input and output a power consumption value of the physical server in a plurality of short ranges obtained by dividing an entire power range of the physical server into a predetermined division number, trains a classifier that receives a metric of the physical server as an input and outputs specification information specifying a corresponding short range, specifies specification information specifying a short range to be applied based on a metric of the workload and the classifier, and estimates power consumption of the workload based on the metric of the workload and a short-range power model corresponding to the short range indicated by the specification information.

According to the invention, it is possible to optimally estimate power consumption of a workload.

### BRIEF DESCRIPTION OF THE DRAWINGS

FIG. 1 is an overall configuration diagram of a calculation system according to an embodiment;

FIG. 2 is a configuration diagram of a workload power estimation server according to the embodiment;

FIG. 3 is a configuration diagram of a metric time-series database according to the embodiment;

FIG. 4A is a diagram showing a distribution of training data for power consumption of a server;

FIG. 4B is a diagram showing overestimation of a single model trained in a long range;

FIG. 5A is a diagram showing division of the training data for a short-range power model according to the embodiment;

FIG. 5B is a configuration diagram of a short-range power model database according to the embodiment;

FIG. 6 is a flowchart of an optimal short-range power model development process according to the embodiment;

FIG. 7 is a flowchart of a workload power consumption estimation process according to the embodiment;

FIG. 8 is a flowchart of a model management process according to the embodiment; and

FIG. 9 is a diagram showing a workload energy consumption and CO₂ emission visualization interface according to the embodiment.

### DESCRIPTION OF EMBODIMENTS

An embodiment will be described with reference to drawings. The embodiment described below does not limit the invention according to the claims, and all elements and combinations thereof described in the embodiment are not necessarily essential to the solution of the invention.

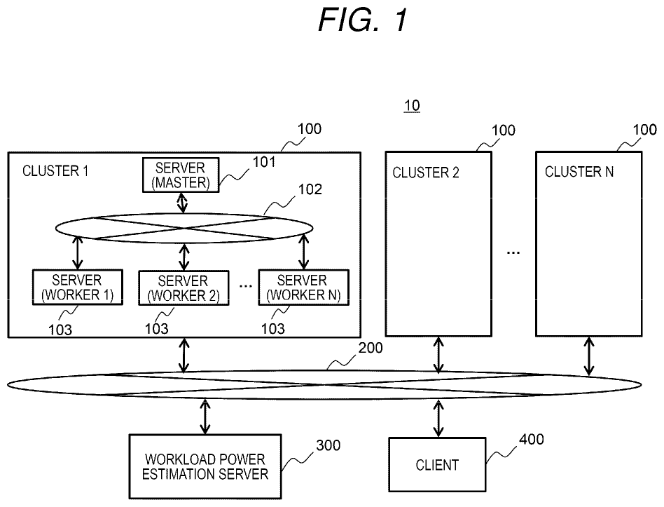

FIG. 1 is an overall configuration diagram of an information system according to an embodiment.

An information system 10 includes a distributed computing system including N (N being one or more) clusters 100, a workload power estimation server 300 as an example of a power consumption estimation system, and a client 400. The cluster 100, the workload power estimation server 300, and the client 400 are connected via a main network 200.

The cluster 100 includes a server (also referred to as a master server) 101 serving as a master, servers (also referred to as worker servers) 103 serving as workers, and a cluster network 102. The master server 101 and the worker server 103 may be, for example, architecturally similar physical servers, that is, servers having the same configuration of processors, memories, storages, networks, and the like. The master server 101 and the worker server 103 communicate with each other via the cluster network 102 using a predetermined protocol.

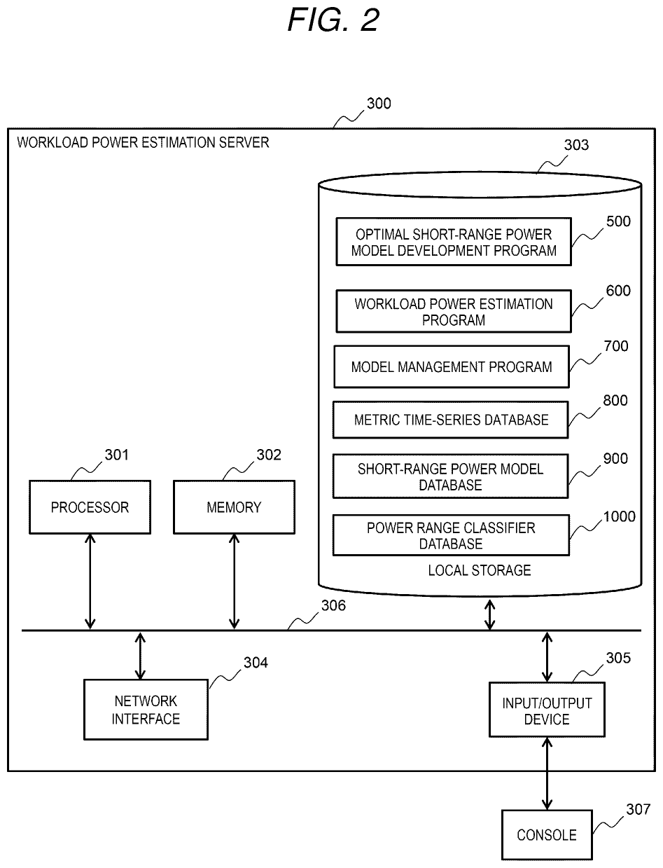

The master server 101 manages and monitors execution of a workload on the worker server 103 in the cluster 100 to which the master server 101 belongs. The master server 101 acquires a metric to which timestamps of server power consumption and a resource usage (for example, a processor usage, a memory usage, a storage usage, a network usage) of a server and a workload are attached from each server via the cluster network 102, for example, at regular intervals using an optimal interface such as a simple network management protocol (SNMP) interface or an application programming interface (API), and pushes the metric to a metric time-series database 800 (see FIG. 2) in the workload power estimation server 300 via the main network 200.

The worker server 103 constitutes one or more virtual machines and executes one or more workloads on the virtual machines.

The workload power estimation server 300 performs a process of training a power estimation model for estimating power consumption by using a metric to which a timestamp is attached, and a process of using a model trained in advance to estimate power consumption of a workload in real time by a metric to which a timestamp is attached.

The client 400 executes the workload in any one of the clusters 100, and monitors the power consumption of the workload estimated by the workload power estimation server 300.

Next, the workload power estimation server 300 will be described in detail.

FIG. 2 is a configuration diagram of the workload power estimation server according to the embodiment.

The workload power estimation server 300 is an example of a computer, and includes a processor 301, a memory 302, a local storage 303, a network interface 304, and an input/output device 305. The processor 301, the memory 302, the local storage 303, the network interface 304, and the input/output device 305 are communicably connected via a system bus 306.

The processor 301 is, for example, a central processing unit (CPU), and fetches a program read into the memory 302 to execute various processes.

The memory 302 is, for example, a random access memory (RAM), and stores programs executed by the processor 301 and necessary data.

The network interface 304 is, for example, an interface such as a wired LAN card or a wireless LAN card, and communicates with other devices (for example, the servers 101 and 103 of the cluster 100, and the client 400) via the main network 200.

The input/output device 305 provides an interface for displaying information on a console 307 and inputting information from the console 307.

The local storage 303 is a permanently recordable recording device such as a hard disk drive (HDD) or a solid state drive (SSD), and records programs and data.

The local storage 303 stores an optimal short-range power model development program 500, a workload power estimation program 600 as an example of the power consumption estimation program, a model management program 700, the metric time-series database 800, a short-range power model database 900, and a power range classifier database 1000.

The optimal short-range power model development program 500 performs a process of developing and training an optimal configuration of a short-range power model by being executed by the processor 301. The workload power estimation program 600 performs a process of estimating power consumption of a monitored workload by being executed by the processor 301. The model management program 700 performs a process of managing the short-range power model and a classifier by being executed by the processor 301. The metric time-series database 800 stores metrics of servers and workloads to which timestamps are attached. The short-range power model database 900 stores the short-range power model. The power range classifier database 1000 stores a classifier (for example, a power range prediction model) that predicts a power range of a workload for each cluster.

Next, a detailed configuration of the metric time-series database 800 will be described.

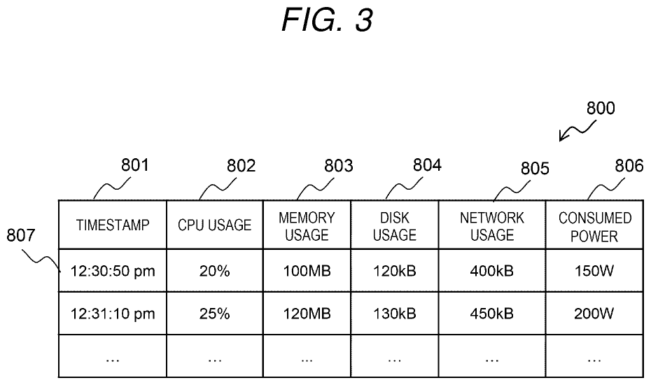

FIG. 3 is a configuration diagram of the metric time-series database according to the embodiment.

The metric time-series database 800 is provided for each cluster 100, and stores metrics of servers and workloads in the corresponding cluster. The metric time-series database 800 stores a record for each time point. The record includes fields of a timestamp 801, a CPU usage 802, a memory usage 803, a disk usage 804, a network usage 805, and a consumed power 806.

The timestamp 801 stores a timestamp indicating a time point at which a metric corresponding to the record is acquired. The CPU usage 802 stores a usage of the CPU (processor) at the time point corresponding to the record. The memory usage 803 stores a usage of the memory at the time point corresponding to the record. The disk usage 804 stores a usage of a disk (local storage) at the time point corresponding to the record. The network usage 805 stores a usage of the network at the time point corresponding to the record. The consumed power 806 stores a consumed power at the time point corresponding to the record. A record 807 in a first line of the metric time-series database 800 shown in FIG. 3 indicates that the CPU usage is 20%, the memory usage is 100 MB, the disk usage is 120 kB, the network usage is 400 kB, and the consumed power is 150 W at 12:30:50 pm.

Next, a distribution of training data used in training of a power consumption model for estimating power consumption of a server will be described.

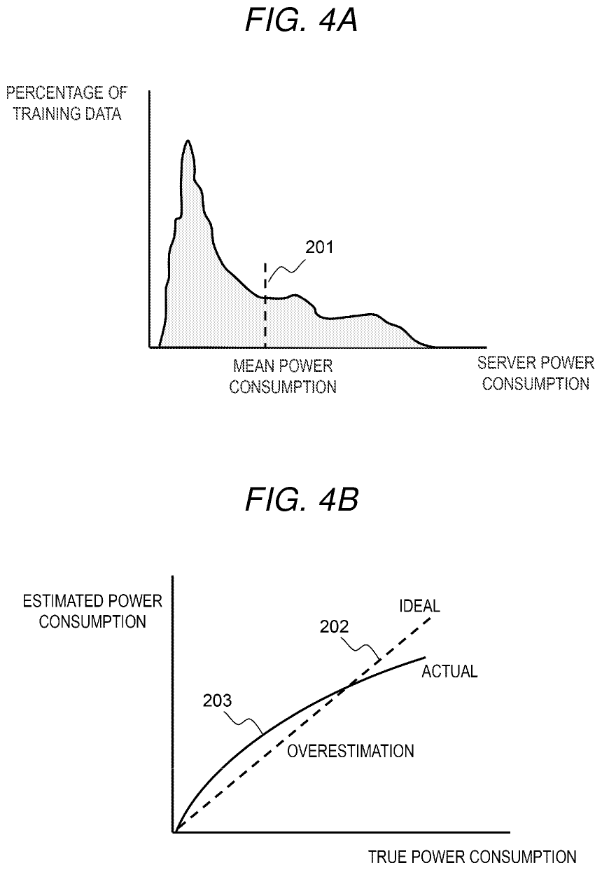

FIG. 4A is a diagram showing a distribution of training data for power consumption of a server.

First, a typical linear recovery model for estimating power consumption P_{pred} of a workload is expressed by the following equation (1).

$${P}_{pred} = {C}_{cpu} \cdot {U}_{cpu} + {C}_{mem} \cdot {U}_{mem} + {C}_{disk} \cdot {U}_{disk} + {C}_{nw} \cdot {U}_{nw} + C \qquad ( 1 )$$

Here, U_{cpu} is the CPU usage, Uₘₑₘ is the memory usage, U_{disk} is the disk usage, and U_{nw} is the network usage. In addition, C_{cpu}, Cₘₑₘ, C_{disk}, and C_{nw} are model coefficients corresponding to the metrics. C is an intercept of a model that can be interpreted as an overhead component of power consumption of a workload, and is caused by an OS (operating system) and middleware that support the workload, an increase in thermal diffusion due to the workload, and other factors. The intercept C is empirically observed to model a mean value of power consumption of a training data point.

As can be seen from FIG. 4A, the distribution of the training data includes a long tail of a high-power data point, and mean power consumption 201 is as shown. A large intercept value of the model causes overestimation of the power consumption of the server and the workload since most of the data points are smaller than the mean power consumption 201.

Next, an estimated value of power consumption of a single linear regression model created using training data of power consumption in a long range (for example, the entire range) will be described.

FIG. 4B is a diagram showing overestimation of a single model trained in a long range.

As shown in FIG. 4B, ideal power consumption estimated by the linear regression model is equal to actual power consumption as indicated by a line 202. On the other hand, when the single linear regression model is created using the training data of the server power consumption having the distribution shown in FIG. 4A, the estimated power consumption is as shown by a line 203 due to a characteristic distribution of the training data and a tendency that the intercept of the model follows the mean value of the training data.

As can be seen from the line 202 and the line 203, a power consumption amount is overestimated for most of the data points, and the consumption power amount is underestimated for the data points of high power.

Next, development of the power model according to the present embodiment will be described.

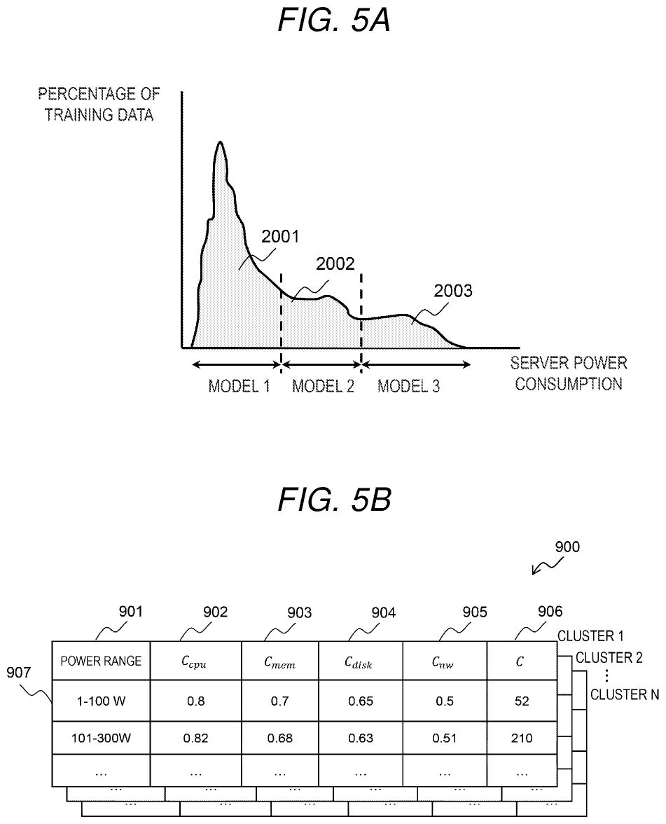

FIG. 5A is a diagram showing division of the training data for a short-range power model according to the embodiment.

In the present embodiment, in order to prevent the overestimation, a short-range power model is developed using short-range training data. In the present embodiment, the training data is divided into several sections (power ranges). Sizes of the respective power ranges may be the same or different.

Data belonging to a predetermined power range is used to construct a short-range power model which is a linear regression model capable of predicting power consumption in the predetermined power range. Specifically, as shown in FIG. 5A, a first power range 2001 is used to construct a model 1 capable of estimating power of only the first power range, similarly, a second power range 2002 is used to construct a model 2 capable of estimating power of only the second power range, and a third power range 2003 is used to construct a model 3 capable of estimating power of only the third power range.

The intercept of the short-range power model for estimating the power of each power range is not a mean of the power consumption of the entire data distribution but a mean of the power consumption in each power range. Accordingly, it is possible to prevent the overestimation in each power range and improve estimation accuracy of the power consumption of the workload.

Next, the short-range power model database 900 that manages the plurality of short-range power models will be described.

FIG. 5B is a configuration diagram of a short-range power model database according to the embodiment.

The short-range power model database 900 includes a table for each cluster. The table for each cluster includes a record of the short-range power model for each power range. The record includes fields of a power range 901, a C_{cpu} 902, a Cₘₑₘ 903, a C_{disk} 904, a C_{nw} 905, and a C 906. The power range of the short-range power model corresponding to the record is stored in the power range 901. The C_{cpu} 902 stores a model coefficient for the CPU usage of the short-range power model corresponding to the record. The Cₘₑₘ 903 stores a model coefficient for the memory usage of the short-range power model corresponding to the record. The C_{disk} 904 stores a model coefficient for the disk usage of the short-range power model corresponding to the record. The C_{nw} 905 stores a model coefficient for the network usage of the short-range power model corresponding to the record. The C 906 stores an intercept value of the short-range power model corresponding to the record. A record 907 in a first row of the table of the cluster 1 indicates that the power range of the short-range power model corresponding to the record is 1 W to 100 W, the C_{cpu} is 0.8, the Cₘₑₘ is 0.7, the C_{disk} is 0.65, the Cow is 0.5, and the C is 52.

Next, a process operation of the workload power estimation server 300 according to the present embodiment will be described.

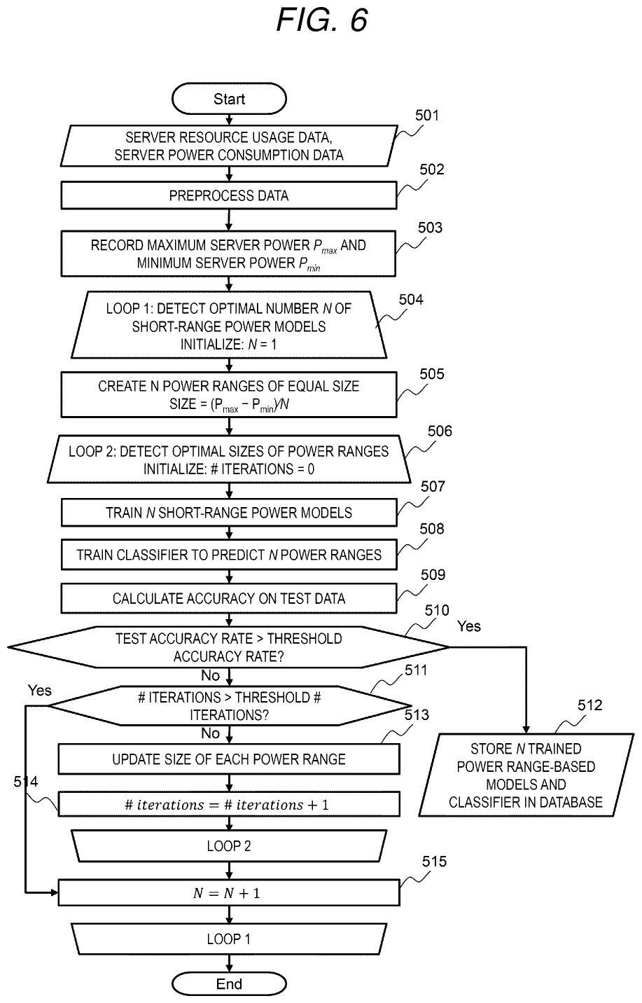

FIG. 6 is a flowchart of an optimal short-range power model development process according to the embodiment.

The optimal short-range power model development process shown in FIG. 6 is a process of developing an optimal short-range power model (optimal short-range power model) related to one server in a cluster. However, in the present embodiment, since each server in the cluster has a uniform configuration, the developed optimal short-range power model can be used for any server. The optimal short-range power model development process is executed, for example, periodically or when instructed by a user.

In step 501, the optimal short-range power model development program 500 inputs server resource usage data with a timestamp and server power consumption data used for training the model. As shown in FIG. 3, the server resource usage data includes a server level metric with a timestamp related to the processor usage, the memory usage, the local storage usage, and the network usage. The server power consumption data includes a value obtained by subtracting a read value of the power consumption of the server in a standby state (server standby power consumption) from a total read value of the server power consumption with the timestamp. The read value of the server standby power consumption can be specified by a read value when the server operates without any workload.

In step 502, the optimal short-range power model development program 500 executes a preprocess on the data with the timestamp, the preprocess including removal of an external value, interpolation or mean of a metric, or replacement of a defect value by an optimal technique such as another method. The preprocess may include time synchronization of metrics acquired from different interfaces. In addition, the preprocess may include using a rolling mean or a moving mean so as to more effectively supplement a pattern in the metric and help remove noise of data.

In step 503, the optimal short-range power model development program 500 records a maximum server power Pₘₐₓ and a minimum server power Pₘᵢₙ.

In step 504, in order to detect an optimal number of short-range power models or an optimal number N of power ranges (that is, an optimal number of sections N of the training data, an optimal division number), the optimal short-range power model development program 500 initializes processing (504 to 515) of a loop 1 with N=1 and starts the processing.

In step 505, the optimal short-range power model development program 500 divides the training data into N power ranges having the same size.

In step 506, the optimal short-range power model development program 500 initializes processing (506 to 514) of a loop 2 for detecting the optimal size of each of the N power ranges of the training data with the number of repetitions (# iteration)=0 and starts the processing.

In step 507, the optimal short-range power model development program 500 trains N short-range power models based on the N power ranges set in the loop 1 and the size of each power range set in the loop 2. As described with reference to FIG. 5A, the optimal short-range power model development program 500 trains each short-range power model using only the training data acquired from the corresponding power range. Here, an input to the short-range power model is a metric related to a processor, a memory, a storage, and a network such as a processor usage, a memory usage, a storage usage, and a network usage, and an output from the short-range power model is a server power consumption amount (power consumption value). The server power consumption amount does not include the power consumption of the server in the standby state. The short-range power model uses, for example, linear regression.

In step 508, the optimal short-range power model development program 500 trains a classifier capable of predicting the power range for a given timestamp or a period using the N power ranges and the sizes of the respective power ranges. Here, an input to the classifier is a metric related to a processor, a memory, a storage, and a network such as a processor usage, a memory usage, a storage usage, and a network usage, and an output from the classifier is a label (specification information) with which a power range can be specified. For example, when the entire power range of 1 W to 800 W is divided into three short ranges of 1 W to 200 W, 201 W to 500 W, and 501 W to 800 W, a label for the power range of 1 W to 200 W is 0, a label for the power range of 201 W to 500 W is 1, and a label for the power range of 501 W to 800 W is 2. As described above, the classifier may be a power range prediction model used to select an optimal short-range power model for power estimation of a workload. The classifier can be developed using an artificial neural network, a decision tree, or any other optimal classification model.

In step 509, the optimal short-range power model development program 500 tests the short-range power model developed in step 507 and the classifier developed in step 508 based on test data in order to calculate accuracy of a server power consumption amount. First, the optimal short-range power model development program 500 predicts the power range for an input of the test data by the classifier. Next, the optimal short-range power model development program 500 uses the short-range power model corresponding to the predicted power range in order to estimate the entire power consumption by using the input of the test data. Next, the optimal short-range power model development program 500 calculates a test accuracy rate by using an optimal accuracy rate measurement method to compare an estimated output with an actual output of the test data. Here, as the accuracy rate measurement method, for example, a root mean square error (RMSE) may be used, or a mean absolute percentage error (MAPE) may be used.

In step 510, the optimal short-range power model development program 500 compares a test accuracy rate with a preset threshold accuracy rate. As a result, when the test accuracy rate exceeds the set threshold accuracy rate (510: Yes), in step 512, the optimal short-range power model development program 500 stores the short-range power model trained by data divided into N (optimal division number) power ranges having the optimal sizes in the short-range power model database 900, and stores the classifier in the power range classifier database 1000.

On the other hand, when the test accuracy rate does not exceed the threshold accuracy rate (510: No), in step 511, the optimal short-range power model development program 500 compares the number of repetitions of the loop 2 with a predetermined repetition threshold. The repetition threshold can be defined based on, for example, complexity of a space and a time of an algorithm.

As a result, when the number of repetitions of the loop 2 does not exceed the predetermined repetition threshold (511: No), in step 513, the optimal short-range power model development program 500 updates the sizes of the N power ranges using one of optimal optimization processes. For example, when the entire power range of 1 W to 800 W is divided into three short ranges of 1 W to 200 W, 201 W to 500 W, and 501 W to 800 W, 1 W to 100 W, 101 W to 300 W, and 301 W to 800 W may be newly set.

In step 514, the optimal short-range power model development program 500 increments (adds 1) the number of repetitions of the loop 2, and repeats the loop 2 from step 507.

On the other hand, when the number of repetitions exceeds the threshold in step 511, the optimal short-range power model development program 500 exits the processing of the loop 2, increments (adds 1) the number N of the power ranges in step 515, and repeats the loop 1 from step 505.

According to the optimal short-range power model development process, the number of optimal power ranges and the sizes of the power ranges are specified, and the short-range power model corresponding to the specified number of power ranges and the classifier can be registered in the database.

Next, a workload power consumption estimation process will be described.

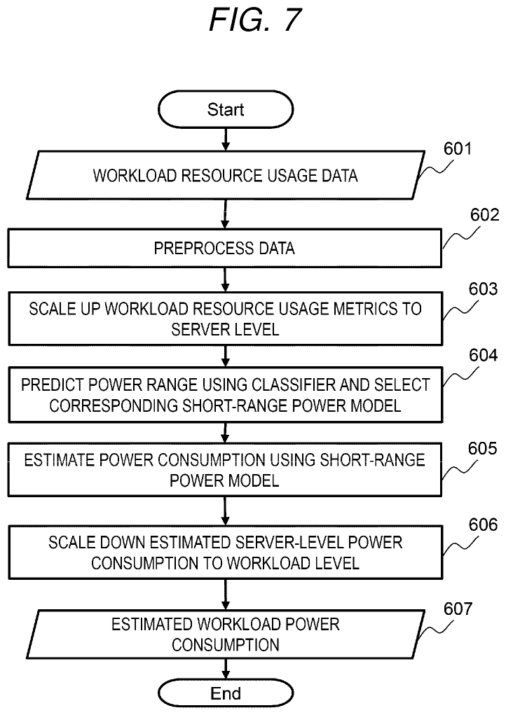

FIG. 7 is a flowchart of a workload power consumption estimation process according to the embodiment.

The workload power consumption estimation process is executed, for example, periodically or when instructed by a user.

In step 601, the workload power estimation program 600 inputs workload resource usage data with a timestamp. As shown in FIG. 3, the workload resource usage data includes a workload level metric with a timestamp related to the processor usage, the memory usage, the local storage usage, and the network usage.

In step 602, the workload power estimation program 600 performs a preprocess on the data with the timestamp. For example, when the short-range power model is trained with respect to the rolling mean or the moving mean of the training data, the preprocess may include using the rolling mean or the moving mean over a period of interest.

In step 603, since the short-range power model is trained by the server level (physical server level) metric, the workload power estimation program 600 applies a predetermined optimal scaling factor to the metric of the workload resource usage to scale up (expand) the server level metric.

For example, a workload metric U_{workload} may be converted into a server level metric Uₛₑᵣᵥₑᵣ by using the following equation (2).

$${U}_{server} = {U}_{workload} / ( the number of processors used in workload ) * ( the total number of processors of the server ) \qquad ( 2 )$$

In step 604, the workload power estimation program 600 inputs the scaled-up workload usage metric to the classifier trained in advance for predicting the power range.

In step 605, the workload power estimation program 600 estimates the power consumption amount in the given period using the short-range power model trained in advance corresponding to the predicted power range.

In step 606, the short-range power model is trained to output the server power consumption amount based on the server level data, and thus the workload power estimation program 600 scales down the server power consumption amount estimated in step 605 to the power consumption amount at the workload level using an optimal predetermined factor.

For example, a server level power consumption amount P∩ₛₑᵣᵥₑᵣ estimated by the short-range power model can be converted into a workload level power consumption prediction value P∩_{workload} using the following equation (3).

$$P {⋂}_{workload} = P {⋂}_{server} / ( the total number of processors of the server ) * ( the number of processors used in workload ) \qquad ( 3 )$$

In step 607, the workload power estimation program 600 outputs the workload power consumption amount estimated in the given period.

According to the above-described workload power consumption estimation process, it is possible to optimally estimate the power consumption amount of the workload.

Next, a model management process will be described.

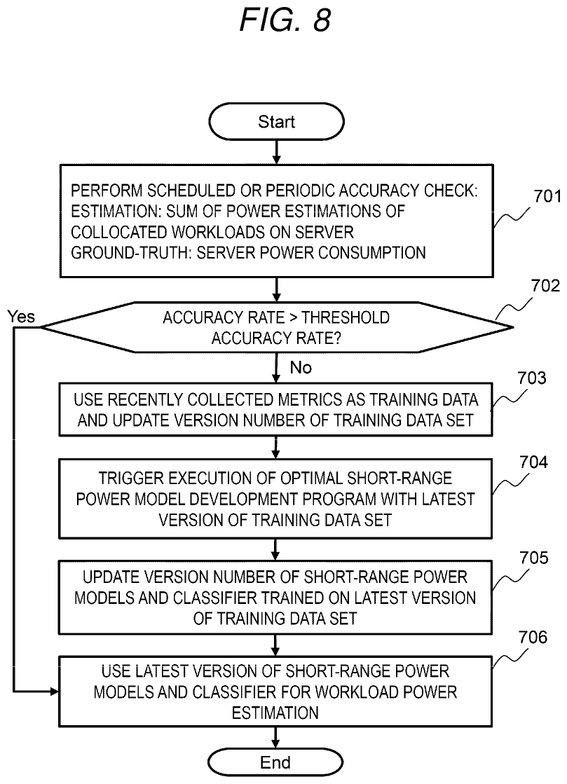

FIG. 8 is a flowchart of a model management process according to the embodiment.

The model management process is executed to ensure that the short-range power models and classifiers have a predefined accuracy rate.

In step 701, the model management program 700 performs scheduled or periodic check on the accuracy rate. Here, in the accuracy rate check, the short-range power model and the classifier are used to calculate the total of the estimated powers in the given period of all the workloads side-by-side in the server to be checked, and the total of the estimated powers is compared with the power consumption amount of the server in this period (here, for example, the total power consumption amount of the server—the standby server power consumption amount) to calculate the accuracy rate.

In step 702, the model management program 700 determines whether the accuracy rate exceeds a threshold accuracy rate.

As a result, when the accuracy rate exceeds the threshold accuracy rate (702: Yes), in step 706, the model management program 700 causes a latest version of short-range power models and classifier of the corresponding cluster to be continuously used to estimate the power consumption amount of the workload executed on the cluster.

On the other hand, when the accuracy rate does not exceed the threshold accuracy rate (702: No), in step 703, the model management program 700 creates a new training data set and updates a version number of the training data set. Here, the new training data set may be, for example, data collected in the metric time-series database 800 after the last update of the short-range power model is performed.

In step 704, the model management program 700 triggers the execution of the optimal short-range power model development program 500 using the latest version of the training data set. Accordingly, the optimal short-range power model development process is executed, and the short-range power models and the classifier suitable for the latest version of the training data set are developed.

In step 705, the model management program 700 updates the version number of the short-range power models and the classifier developed with the latest version of the training data set in step 704.

In step 706, the model management program 700 uses the latest version of the short-range power models and classifier of the corresponding cluster to estimate the power consumption amount of the workload executed on the cluster.

According to the model management process, the short-range power models and the classifier can be updated to an optimal state.

Next, workload energy consumption and CO₂ emission visualization interface (visualization interface) displayed by the workload power estimation server 300 will be described.

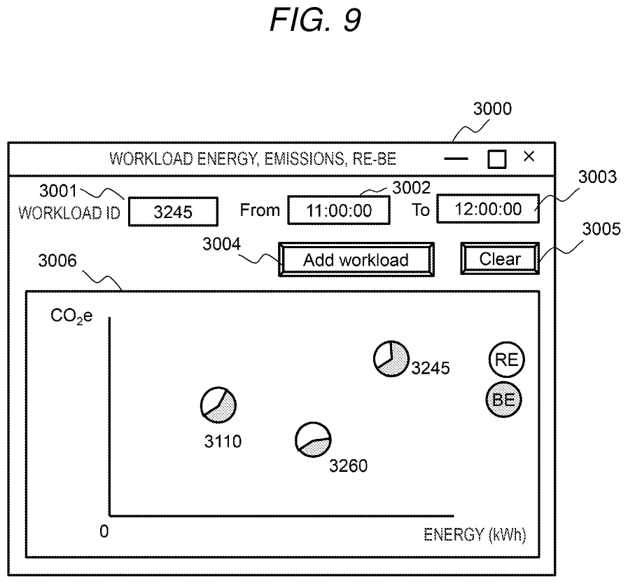

FIG. 9 is a diagram showing a workload energy consumption and CO₂ emission visualization interface according to the embodiment.

A visualization interface 3000 is an interface showing energy (power) consumption in a designated period of a designated workload, and a composition of renewable energy (RE) and brown energy (BE) in the energy consumption, and is displayed on, for example, the console 307 or the client 400 by, for example, the workload power estimation program 600.

The visualization interface 3000 includes a workload ID input area 3001, a start period input area 3002, an end period input area 3003, a workload add button 3004, a clear button 3005, and a graph display area 3006.

The workload ID input area 3001 is an area for inputting an ID (workload ID) of a workload to be displayed in the graph display area 3006. The start period input area 3002 is an area for inputting a start time point of a period targeted for power consumption. The end period input area 3003 is an area for inputting an end time point of the period targeted for power consumption. The workload add button 3004 is a button for receiving an instruction to add, to the graph display area 3006, an object indicating power consumption for the period input to the start period input area 3002 and the end period input area 3003 for the workload of the workload ID input to the workload ID input area 3001. The clear button 3005 is a button for receiving an instruction to delete an object of the workload of the input workload ID from the graph display area 3006. The graph display area 3006 is an area for displaying an object indicating the power consumption and a ratio between RE and BE for the added workload. The information on the RE and the BE corresponding to the workload can be specified by acquiring information on the power supplied to the server that executes the workload from the outside.

The invention is not limited to the above-mentioned embodiments, and can be appropriately corrected and implemented without departing from the gist of the invention.

For example, a part or all of the processing performed by the processor in the above embodiments may be performed by a dedicated hardware circuit. Programs in the embodiments described above may be installed from a program source. A program source may be a program distribution server or a recording medium (for example, a portable recording medium).

What is claimed is:

1. A power consumption estimation system that estimates power consumption of a workload executed on a physical server, the power consumption estimation system comprising:
a processor, wherein
the processor
trains a plurality of short-range power models as power models that receive a metric of the physical server as an input and output a power consumption value of the physical server in a plurality of short ranges obtained by dividing an entire power range of the physical server into a predetermined division number,
trains a classifier that receives a metric of the physical server as an input and outputs specification information specifying a corresponding short range,
specifies specification information specifying a short range to be applied based on a metric of the workload and the classifier, and
estimates power consumption of the workload based on the metric of the workload and a short-range power model corresponding to the short range indicated by the specification information.

2. The power consumption estimation system according to claim 1, wherein
the processor
changes the division number into which the entire power range of the physical server is divided, and trains the short-range power model for each of the short ranges of the division number, detects a division number when an accuracy rate exceeds a predetermined threshold by calculating the accuracy rate of the power consumption estimated using the short-range power model in the division number, and
determines the detected division number as a division number when estimating the power consumption of the workload.

3. The power consumption estimation system according to claim 1, wherein
the processor
changes a size of the short range and trains the short-range power model for each short range according to each size, detects a size of the short range when an accuracy rate exceeds a predetermined threshold by calculating the accuracy rate of the power consumption estimated using the short-range power model, and
determines the detected size of the short range as a size of the short range when estimating the power consumption of the workload.

4. The power consumption estimation system according to claim 1, wherein
the short-range power model outputs power consumption obtained by subtracting power consumption in a standby state of the physical server from total power consumption of the physical server as the power consumption of the physical server.

5. The power consumption estimation system according to claim 1, wherein
the processor
converts a metric of the workload into a metric of a physical server level,
specifies a short range corresponding to the metric at the physical server level by inputting the metric at the physical server level to the classifier,
inputs the metric at the physical server level to a short-range power model corresponding to the specified short range to estimate power consumption at the physical server level, and
converts the estimated power consumption into power consumption at a level of the workload.

6. The power consumption estimation system according to claim 1, wherein
the processor
acquires new training data including a metric and power consumption of a physical server after training a previous short-range power model,
changes a division number into which an entire power range of the physical server is divided, and trains the short-range power model for each of the short ranges of the division number using the new training data, detects an optimal division number as a division number when an accuracy rate exceeds a predetermined threshold by calculating an accuracy rate of power consumption estimated using the short-range power models in the division number, and
determines the detected optimal division number as a division number when estimating the power consumption of the workload.

7. The power consumption estimation system according to claim 6, wherein
the processor determines, based on the power consumption of the physical and a total power consumption estimated by the short-range power models for all workloads side-by-side in the physical server, whether the estimation of the power consumption for the workload by the short-range power model has predetermined accuracy, and when the estimation of the power consumption does not have the predetermined accuracy, the processor acquires the new training data, detects the optimal division number using the new training data, and determines the optimal division number as the division number for estimating the optimal division number.

8. The power consumption estimation system according to claim 1, wherein
the processor displays the estimated power consumption of the workload.

9. A power consumption estimation method performed by a power consumption estimation system that estimates power consumption of a workload executed on a physical server, the power consumption estimation method comprising:
the power consumption estimation system
training a plurality of short-range power models as power models that receive a metric of the physical server as an input and output a power consumption value of the physical server in a plurality of short ranges obtained by dividing an entire power range of the physical server into a predetermined division number;
training a classifier that receives a metric of the physical server as an input and specifies a corresponding short range;
specifying a short range to be applied based on a metric of the workload and the classifier; and
estimating the power consumption of the workload based on the metric of the workload and a short-range power model corresponding to the specified short range.

10. A power consumption estimation program that causes a computer to execute processing for estimating power consumption of a workload executed on a physical server, the power consumption estimation program causing
the computer to:
train a plurality of short-range power models as power models that receive a metric of the physical server as an input and output a power consumption value of the physical server in a plurality of short ranges obtained by dividing an entire power range of the physical server into a predetermined division number,
train a classifier that receives a metric of the physical server as an input and specifies a corresponding short range,
specify a short range to be applied based on a metric of the workload and the classifier, and
estimate power consumption of the workload based on the metric of the workload and a short-range power model corresponding to the specified short range.
